(19) United States
(12) Patent Application Publication
(10) Pub. No.: US 2026/0170234 A1
(43) Pub. Date: Jun. 18, 2026

(54) MANAGING META INFORMATION ON BINARY LEVEL

(71) Applicant: INTERNATIONAL BUSINESS MACHINES CORPORATION, ARMONK, NY (US)

(72) Inventors: Alexander Merschel, Stuttgart (DE); Stephan Hiller, Aidlingen (DE); Oliver Harm, Stuttgart (DE); Yannick Saillet, Stuttgart (DE); Stefan Renner, München (DE)

(21) Appl. No.: 19/055,075

(22) Filed: Feb. 17, 2025

(30) Foreign Application Priority Data
Dec. 16, 2024 (GB) 2418403.8

(51) Int. Cl. G06F 40/126

(52) U.S. Cl. CPC G06F 40/126

(57) ABSTRACT

The present disclosure relates to a method for encoding character data using an encoding scheme, the encoding scheme being configured to represent, in accordance with a formatting scheme, an original binary value of each character of a predefined character set into a unique set of one or more code units of the encoding scheme, the method comprising for a specific token: representing metadata descriptive of the specific token with a binary value, referred to as metadata binary value; for each character in the specific token: representing the character with a binary value, referred to as character binary value; creating, in accordance with the formatting scheme, a unique set of code units including at least part of the metadata binary value and character binary value; storing the specific token by storing resulting one or more sets of code units.

### BACKGROUND

The present invention relates to the field of digital computer systems, and more specifically, to a method for encoding character data using an encoding scheme.

Data protection mandates the implementation of measures to safeguard sensitive information, such as personally identifiable data. To achieve compliance, systems should establish processes for identifying the locations of sensitive data and ensuring its proper handling, often through techniques like data masking. Various solutions are available to assist in identifying sensitive data, applying appropriate classification labels, and enforcing the necessary protection measures. Nevertheless, there is still room for further refinement in these solutions.

### SUMMARY

Various embodiments provide a method for encoding character data using an encoding scheme, computer program product and computer system as described by the subject matter of the independent claims. Advantageous embodiments are described in the dependent claims. Embodiments of the present invention can be freely combined with each other if they are not mutually exclusive.

In one aspect, the invention relates to a method for encoding character data using an encoding scheme, the encoding scheme being configured to represent, in accordance with a formatting scheme, an original binary value of each character of a predefined character set into a unique set of one or more code units of the formatting scheme, the original binary value being obtained by a binary encoding technique, the method comprising for a specific token: representing metadata descriptive of the specific token with a binary value, referred to as metadata binary value; for each character in the specific token: representing the character with a binary value, referred to as character binary value; creating, in accordance with the formatting scheme, from at least part of the metadata binary value and the character binary value a unique set of code units including the at least part of the metadata binary value and the character binary value; storing the specific token by storing the resulting one or more sets of code units.

In one aspect the invention relates to a computer program product comprising a computer-readable storage medium having computer-readable program code embodied therewith, the computer-readable program code configured to implement the method of the above embodiment.

In one aspect the invention relates to a computer system for encoding character data using an encoding scheme, the encoding scheme being configured to represent, in accordance with a formatting scheme, an original binary value of each character of a predefined character set into a unique set of one or more code units of the formatting scheme, the original binary value being obtained by a binary encoding technique, the computer system being configured for: for a specific token: representing metadata descriptive of the specific token with a binary value, referred to as metadata binary value; for each character in the specific token: representing the character with a binary value, referred to as character binary value; creating, in accordance with the formatting scheme, from at least part of the metadata binary value and the character binary value a unique set of code units including the at least part of the metadata binary value and the character binary value; storing the specific token by storing the resulting one or more sets of code units.

### BRIEF DESCRIPTION OF THE DRAWINGS

In the following embodiments of the invention are explained in greater detail, by way of example only, making reference to the drawings in which:

FIG. 1 is a flowchart of a method for encoding character data using an encoding scheme in accordance with an example of the present subject matter.

FIG. 2 is a flowchart of a method for encoding an unstructured document using an encoding scheme in accordance with an example of the present subject matter.

FIG. 3 is a flowchart of a method for decoding the encoded unstructured document of FIG. 2 in accordance with an example of the present subject matter.

FIG. 4 is a diagram illustrating a method for encoding a specific token in accordance with an example of the present subject matter.

FIG. 5 is a computing environment in accordance with an example of the present subject matter.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

By keeping the metadata about the classification of the data together with the data itself, there may be better flexibility in managing sensitive information, and changes to data may be tracked independently of its classification, ensuring more efficient updates across multiple systems. Access to tokens, with the present subject matter, may be more secure because the access may require usage of a catalog or a tool that leverages the stored metadata. For example, the present subject matter may enable to store metadata applicable to tokens such as single words, sentences, or values of a document, within the document itself rather than externally. This may ensure that when the document is updated, the metadata may remain in sync, preventing misalignment due to incorrect offsets. Additionally, when the document is copied, the metadata may not be lost as it is embedded within the data. Even if document is compromised, sensitive data may remain protected, as masking mechanisms may be enabled through strict catalog access controls.

The present subject matter may provide a method for encoding character data using an encoding scheme. Character data refers to any data composed of individual characters, which may include letters, digits, punctuation marks, symbols, and control characters. In digital systems, these characters may be represented using specific encoding schemes that may translate each character into a unique sequence of binary digits. This binary sequence may be how the character data is stored, enabling computers to process and interpret the information. The binary sequences may be stored in various formats, including structured documents or unstructured data formats such as text files, databases, or other data repositories.

The encoding scheme may be a method used to convert characters into binary values so they can be stored and processed by computers. The encoding scheme may be associated or used for encoding characters of a specific character set. The encoding scheme is configured to represent an original binary value of each character of the character set by a unique set of one or more code units of the encoding scheme in accordance with a formatting scheme. The formatting scheme may define how the original binary value may be structured in code units. The representation of the original binary values may be performed such that each character in the character set is assigned a specific sequence of code units that uniquely identifies it in the encoding scheme. The code unit may be a bit sequence. The code unit may be the minimum bit sequence used to encode a character with the encoding scheme. The original binary value may refer to the raw binary representation of the given character based on the binary encoding technique. For example, the given character may be mapped or associated with a unique decimal value, wherein the original binary value may be obtained by applying the binary encoding technique on that decimal value. For example, given the character ‘M’, the corresponding decimal value may be 77. The conversion from the decimal value to binary according to the binary encoding technique may be performed following these steps: 77÷2=38, remainder 1; 38÷2=19, remainder 0; 19÷2=9, remainder 1; 9÷2=4, remainder 1; 4÷2=2, remainder 0; 2÷2=1, remainder 0; and 1÷2=0, remainder 1. This results in the original binary value ‘1001101’ that represents the character ‘M’.

Hence, given the encoding scheme as described above, the present method may be performed for a specific token. The specific token may be any token, where the token may be the smallest sequence of characters that has semantic meaning. The token may, for example, be part of an electronic document or a database. For example, in natural language processing (NLP), a token may refer to a word or punctuation mark. For example, in the sentence “Hello, world!”, the tokens may be “Hello”, “,”, “world”, and “!”. The specific token may comprise one or more characters. The present method may be performed for the specific token as follows. Metadata descriptive of the specific token may be determined. The metadata may be represented with a binary value referred to as metadata binary value. The binary encoding technique may, for example, be used to represent the metadata by the metadata binary value. For each character in the specific token, the character may be represented with a binary value, referred to as character binary value, and a unique set of code units may be created in accordance with the formatting scheme, such that the set of code units include at least part of the metadata binary value and the character binary value. This may result in one or more sets of code units depending on the number of characters of the specific tokens. If, for example, n is the number of characters in the specific token, n sets of code units may result. The character may be represented with the character binary value using the binary encoding technique. The specific token may be stored by storing the resulting one or more sets of code units. Storing metadata alongside the actual data may allow to maintain important contextual information (e.g., classification) about the specific token, which can be used for data protection, validation, or other purposes.

According to one example, the at least part of the metadata binary value is a distinct part of the metadata binary value that is associated with the character. For example, the metadata binary value may be split into parts, each part being associated with a respective character of the specific token. Splitting the metadata binary value into distinct parts, each associated with a specific character of the token, may allow for more detailed and specific metadata control, providing finer granularity in processing or analysis. This method may result in more efficient storage, especially when the metadata associated with each character is relatively small, thereby reducing redundancy. Additionally, it may offer flexible handling, as it can adapt to scenarios where only a subset of metadata is relevant for certain characters within the token.

According to one example, the at least part of the metadata binary value is the metadata binary value. That is, each character of the specific token may be associated with the full content of the metadata. Associating each character of the specific token with the entire metadata binary value may simplify the process, as there is no need to split or manage distinct parts. This approach may ensure that every character has access to the complete metadata, providing a holistic view and eliminating the risk of missing information during processing. Additionally, it may facilitate ease of retrieval, as accessing the full metadata directly for each character can speed up retrieval processes without the need to reconstruct metadata from individual parts.

According to one example, the encoding scheme is a predefined multi-byte encoding scheme, wherein the representation of the character and/or the representation of the metadata is performed such that a concatenation of the at least part of the metadata binary value and the character binary value represents, in accordance with the binary encoding technique, an existing character of a multi-byte range of the character set. The existing character may be replaced by the character and the associated at least part of the metadata.

Indeed, the resulting concatenated binary sequence may correspond to an existing character within the multi-byte character range. This means that the process may use the combined metadata and character binary values to effectively replace or represent a character within the predefined encoding scheme. For example, emojis, which may not be necessary for encoding database data, can be substituted in this manner.

This approach may enhance character representation by embedding metadata directly into the character's encoding, providing additional context or information with each character. Utilizing an established multi-byte encoding, like UTF-8 or UTF-16, may ensure compatibility with existing systems while efficiently expanding character functionality.

According to one example, the encoding scheme is a predefined multi-byte encoding scheme, wherein the representation is performed such that a concatenation of the at least part of the metadata binary value and the character binary value represents, in accordance with the binary encoding technique, an unused character that is outside multi-byte ranges of the character set.

The encoding scheme may be a predefined multi-byte encoding, such as UTF-8 or UTF-16, where characters are typically represented using one or more bytes. In this approach, the representation may involve concatenating at least part of the metadata binary value with the character binary value to create a new binary sequence. This sequence is designed to correspond to an unused character that lies outside the standard multi-byte ranges of the character set. The unused character may be character that is not currently assigned within the multi-byte ranges of the character set, providing a free space that can be repurposed for custom encoding needs.

By using characters outside the existing multi-byte ranges, this scheme may ensure that additional metadata does not interfere with standard characters, preserving the integrity of the original encoding. It may allow for seamless integration of custom metadata, enabling the attachment of extra information, such as annotations or formatting details, directly within the encoding without relying on external storage.

According to one example, creating the set of code units comprises: integrating the metadata binary value and character binary value into a combined binary value by padding zero or more bits between the metadata binary value and character binary value and determining the specific set of code units that comprise the combined binary value in accordance with the formatting scheme.

The character binary value may be a first set of bits and the metadata binary value may be a second set of bits. The integration of the metadata binary value and character binary value into a combined binary value may, for example, be performed by placing the first set of bits adjacent to the second set of bits by zero or more padding bits. Zero or more padding bits might be inserted between the metadata and character binary values to ensure that the combined binary value conforms to a predefined format (e.g., a fixed length). The padding may be performed such that the total number of bits in the combined binary value enables to obtain a unique set of code units in accordance with the formatting scheme. That is, if the total number of bits in the first set of bits and the second set of bits enables to obtain a unique set of code units, there may be no (zero) padding.

According to one example, the padding is performed such that the combined binary value has a number of bits higher than a maximum number of bits that can represent the character set. For example, the character set may comprise a collection of characters so that each character may be represented by a set of bits which is smaller than or equal than the maximum number of bits. This may ensure that the combined binary value corresponds with a character that does not belong to the character set and thus may avoid using the same code units.

For example, if the formatting scheme is the formatting scheme of UTF-8, to store metadata within the information/data it is linked to, this example may use previously unused UTF-8 multibyte code points to store metadata on a code point level. Indeed, UTF-8 has 1048576 defined code points that can be represented in up to 4-byte multibyte sequences. Anything above the 4-byte multibyte sequence may still be technically plausible within the UTF-8 structure.

According to one example, the method further comprises: parsing an electronic document for identifying sensitive tokens in the electronic document and repeating the method for each sensitive token of the sensitive tokens as the specific token, wherein the sensitive tokens are identified based on a security access criterion, wherein the storage of each sensitive token comprises replacing existing one or more code units of the sensitive token in the electronic document by the one or more sets of code units of the sensitive token. The method of this example may involve scanning the electronic document to identify sensitive tokens according to the security access criterion. For each sensitive token detected, the method is applied to that sensitive token, where the term “specific token” in the method is to be understood as referring to the “sensitive token”.

The sensitive token may be a token that meets the security access criterion either individually or in combination with one or more additional tokens in the electronic document, with the one or more additional tokens also being classified as sensitive tokens in the latter case. The security access criterion may, for example, require a token to possess certain attributes, be part of a specific token category, or be linked with one or more additional tokens in a way that collectively fulfils the security access criterion. The sensitive token may, for example, represent a financial data category or be a personally identifiable information (PII) token. This may enhance data security and privacy by replacing sensitive tokens in a document with different sets of code units, effectively masking the original information while preserving its integrity. It may allow for automated, scalable identification of sensitive data, simplifying storage and transmission without compromising the document's structure. Furthermore, it may ensure compatibility with existing encoding schemes and safeguard sensitive information against unauthorized access.

According to one example, the character set comprises any one of UNICODE, ASCII or ISO-8859-1.

According to one example, the formatting scheme is a formatting scheme of any one of: UTF encoding scheme or ASCII encoding scheme.

According to one example, the formatting scheme is a formatting scheme of UTF-8 encoding scheme, wherein the set of code units is higher than four code units.

According to one example, the set of code units is five or six code units. Using five or six code units may allow the encoding scheme to represent a broader range of characters that may go beyond existing multi-byte encoding schemes.

According to one example, the code units are bytes respectively.

According to one example, the method further comprises before the representation of the characters of the specific token, encrypting the specific token, wherein the characters of the specific token are encrypted characters of the encrypted specific token. The method of this example specifies that the specific token, for which the metadata is determined and the one or more sets of code units are created and then stored, is an encrypted version of an original token. Physically, the encrypted token and the original token may be similar in format or structure; however, they differ semantically because the encrypted token may obscure the original token's meaning, making it unreadable without decryption.

For example, before representing the characters of the specific token the token is first encrypted. Encryption may involve transforming the specific token into an encoded format that is unreadable without a decryption key. As a result, the characters of the specific token that are eventually represented are the encrypted form of the original characters. Essentially, the specific token is encrypted into a new, secure version, and the characters of this encrypted token are what get used in subsequent operations.

Encrypting the specific token before its representation may ensure enhanced security by protecting sensitive information, as intercepted data cannot be accessed without the decryption key. This method may maintain data protection during transmission, storage, or processing and can be applied across various domains, including secure communications and databases.

According to one example, the specific token is a database attribute value that is stored in a database.

The specific token may refer to a database attribute value, which is a piece of data stored within a database. In database systems, data may be organized into tables composed of rows and columns. Each column represents an attribute, such as a name, age, or product ID, and each row holds the corresponding values for these attributes. The specific token may be one of these values.

Treating a database attribute value as a token may allow for granular data management, enabling fine-grained operations like encryption or metadata tagging on individual pieces of data, thereby enhancing security without affecting the entire database.

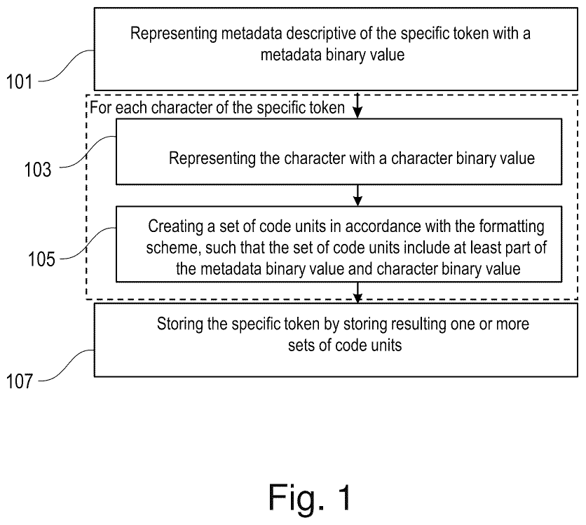

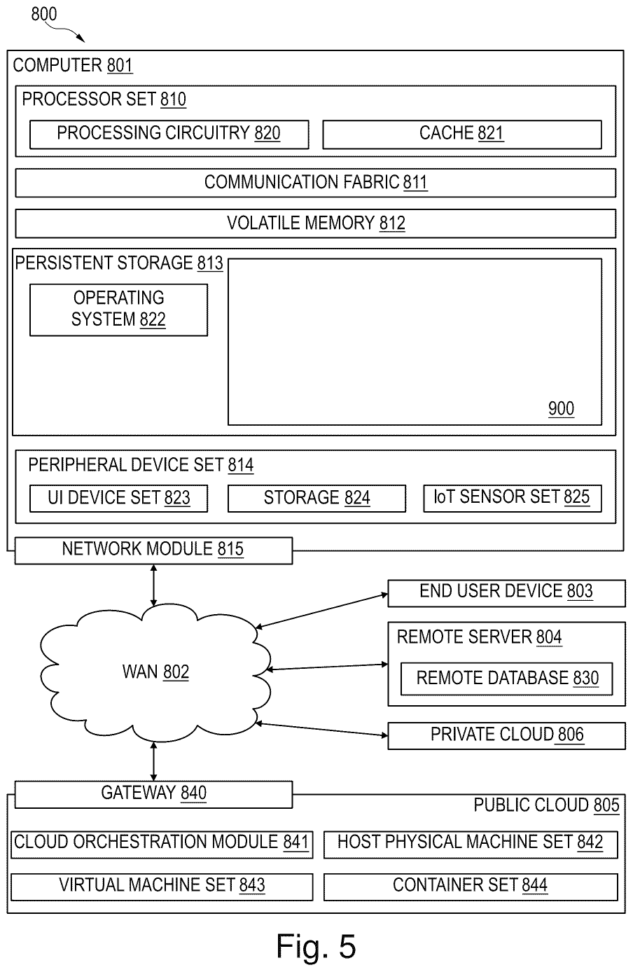

FIG. 1 is a flowchart of a method for encoding character data using an encoding scheme in accordance with an example of the present subject matter. For the purpose of explanation, the method described in FIG. 1 may be implemented in the system illustrated in FIG. 5 but is not limited to this implementation. The encoding scheme is configured to represent, in accordance with a formatting scheme, an original binary value of each character of a predefined character set into a unique set of one or more code units of the encoding scheme. The original binary value is obtained from the character by a binary encoding technique.

Metadata descriptive of a specific token may be represented in step 101 with a binary value, referred to as metadata binary value. Steps 103 and 105 may be performed for each character in the specific token. In step 103, the character may be represented with a binary value, referred to as character binary value. In step 105, a unique set of code units may be created in accordance with the formatting scheme, such that the set of code units include at least part of the metadata binary value and the character binary value.

The specific token may be stored in step 107 by storing resulting one or more sets of code units.

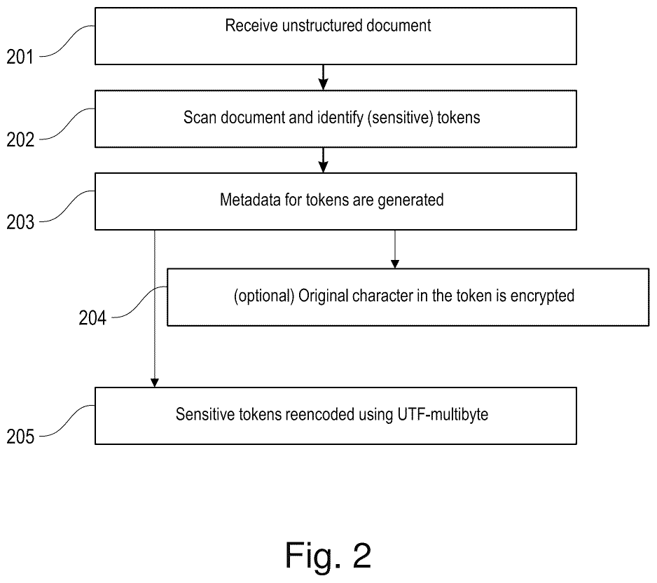

FIG. 2 is a flowchart of a method for encoding data using an encoding scheme in accordance with an example of the present subject matter. For the purpose of explanation, the method described in FIG. 2 may be implemented in the system illustrated in FIG. 5 but is not limited to this implementation.

The method begins with the reception of an unstructured document in step 201, which likely contains various types of data, including sensitive information. The next step 202 involves scanning the document and identifying sensitive tokens, where the system detects sensitive data, such as personally identifiable information (PII). Following this, metadata for the tokens are generated in step 203, capturing details about the tokens, such as their type, location, and sensitivity level. An optional step 204 is included where the original characters in the sensitive tokens are encrypted, adding an additional security layer by ensuring that even if exposed, the original data remains unreadable without proper decryption. The process concludes with re-encoding the sensitive tokens using a UTF-multibyte encoding scheme in step 205, ensuring that the tokens are stored or transmitted in a secure and standardized format that is compatible with various systems and platforms. This method may represent a specific encoding referred to as Encoding 200.

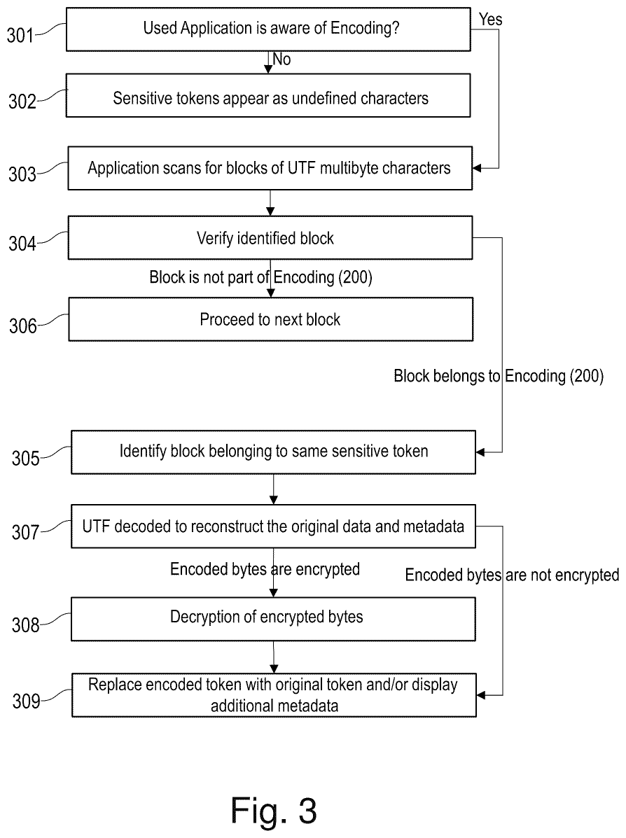

FIG. 3 is a flowchart of a method for encoding data using an encoding scheme in accordance with an example of the present subject matter. For the purpose of explanation, the method described in FIG. 3 may be implemented in the system illustrated in FIG. 5 but is not limited to this implementation.

The method begins in step 301 by checking if the used application is aware of the encoding as described in FIG. 2. If the application is not aware, sensitive tokens appear as undefined characters in step 302, meaning the application may not interpret the data correctly. If the application is aware of the encoding, it scans for blocks of UTF multibyte characters in step 303, identifying potential encoded data. Once a block is identified, the next step 304 is to verify the identified block to determine if the block belongs to the specific encoding used for the token (Encoding 200). If the block belongs to Encoding 200, the system identifies the block as part of the same sensitive token in step 305 and proceeds with decoding. If the block is not part of Encoding 200, the process proceeds to the next block in step 306. For blocks identified as part of Encoding 200, the next step 307 is decoding the UTF data to reconstruct the original data and metadata. The process then checks whether the encoded bytes are encrypted. If they are, the system proceeds with decryption of encrypted bytes in step 308; if they are not encrypted, this step is skipped. Finally, the system either replaces the encoded token with the original token and/or displays additional metadata in step 309 to complete the decoding process.

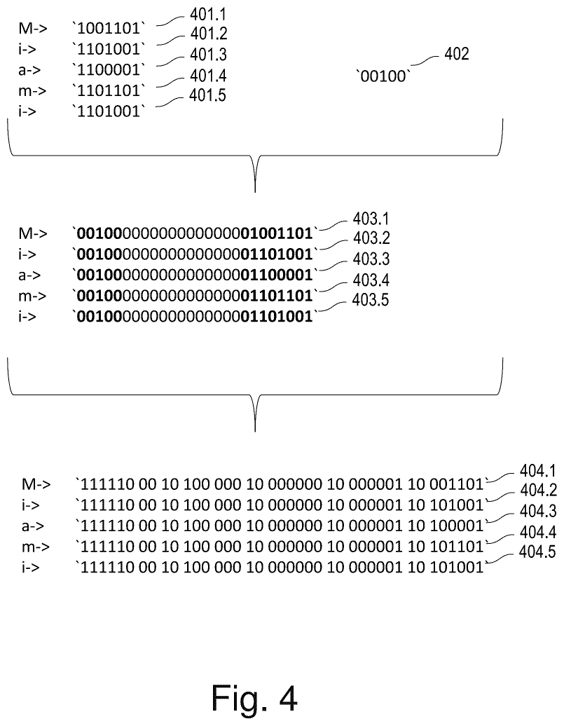

FIG. 4 is a block diagram illustrating a method for encoding the specific token “Miami” using an encoding scheme in accordance with an example of the present subject matter. For the purpose of explanation, the method described in FIG. 4 may be implemented in the system illustrated in FIG. 5 but is not limited to this implementation. In this example, the formatting scheme is a formatting scheme of UTF-8 encoding scheme.

Each character of the specific token is represented by a respective character binary value. This is indicated in FIG. 4, where the character ‘M’ is represented with the character binary value 401.1, the character ‘i’ is represented with the character binary value 401.2, the character ‘a’ is represented with the character binary value 401.3, the character ‘m’ is represented with the character binary value 401.4, and the character ‘i’ is represented with the character binary value 401.5.

Metadata is defined or determined for the specific token ‘Miami’. The metadata is represented with the metadata binary value 402.

For each character of the specific token ‘Miami’, the metadata binary value and the character binary value may be integrated into a combined binary value. This may, for example, be performed by padding 10 digits between the metadata binary value and the character binary value. Alternatively, the binary encoding technique may be configured to provide the character binary value of each character in the token, including the originally padded zeros. This is indicated in FIG. 4, where the character ‘M’ is associated with the combined binary value 403.1 which is obtained from the metadata binary value 402 and the character binary value 401.1, the character ‘i’ is associated with the combined binary value 403.2 which is obtained from the metadata binary value 402 and the character binary value 401.2, the character ‘a’ is associated with the combined binary value 403.3 which is obtained from the metadata binary value 402 and the character binary value 401.3, the character ‘m’ is associated with the combined binary value 403.4 which is obtained from the metadata binary value 402 and the character binary value 401.4, and the character ‘i’ is associated with the combined binary value 403.5 which is obtained from the metadata binary value 402 and the character binary value 401.5.

The formatting scheme may be used to create for each character of the specific token ‘Miami’ a set of code units such that the set of code units include the metadata binary value and character binary value of the each character. Since the formatting scheme is of the UTF-8 encoding scheme, the code units are bytes, and the formatting scheme may use for multi-byte characters, specific prefixes in the first byte to indicate the number of bytes in the sequence. For instance, for a 2-byte sequence, the first byte starts with prefix of size 3: “110”, and the second byte with “10”. For a 3-byte sequence, the first byte starts with prefix of size 4: “1110”, followed by two bytes starting with “10”. In a 4-byte sequence, the first byte begins with prefix of size 5: “11110”, followed by three bytes starting with “10”. However, since the length of the combined binary values is higher than 21 which is the maximum number of bits that can represent the character set associated with the UTF-8 encoding scheme, the maximum number four of bytes of the UTF-8 encoding scheme may not be sufficient to encode the combined binary value. For that, the same logic of the formatting scheme may be followed so that the first byte begins with prefix of size 6: “111110”, followed by four bytes starting with “10”. This is what indicated in FIG. 4, where each character of the specific token ‘Miami’ is associated with a respective set of five code units (i.e., 5 bytes). The character ‘M’ is associated with the set of five code units 404.1, character ‘i’ is associated with the set of five code units 404.2, character ‘a’ is associated with the set of five code units 404.3, character ‘m’ is associated with the set of five code units 404.4, and the character ‘i’ is associated with the set of five code units 404.5.

The present subject matter may comprise the following clauses.

Clause 1. A method for encoding character data using an encoding scheme, the encoding scheme being configured to represent, in accordance with a formatting scheme, an original binary value of each character of a predefined character set into a unique set of one or more code units of the formatting scheme, the original binary value being obtained by a binary encoding technique, the method comprising for a specific token: representing metadata descriptive of the specific token with a binary value, referred to as metadata binary value; for each character in the specific token: representing the character with a binary value, referred to as character binary value; creating, in accordance with the formatting scheme, from at least part of the metadata binary value and the character binary value a unique set of code units including the at least part of the metadata binary value and the character binary value; storing the specific token by storing the resulting one or more sets of code units.

Clause 2. The method of clause 1, the at least part of the metadata binary value being a distinct part of the metadata binary value that is associated with the character.

Clause 3. The method of clause 1, the at least part of the metadata binary value being the metadata binary value.

Clause 4. The method of any of the preceding clauses 1 to 3, wherein the encoding scheme is a predefined multi-byte encoding scheme, wherein the representations is performed such that a concatenation of the at least part of the metadata binary value and the character binary value represents, in accordance with the binary encoding technique, an existing character of a multi-byte range of the character set, thereby replacing the existing character by the character and the associated at least part of the metadata.

Clause 5. The method of any of the preceding clauses 1 to 3, wherein the encoding scheme is a predefined multi-byte encoding scheme, wherein the representation is performed such that a concatenation of the at least part of the metadata binary value and the character binary value represents, in accordance with the binary encoding technique, an unused character that is outside multi-byte ranges of the character set.

Clause 6. The method of any of the preceding clauses 1 to 5, wherein creating the set of code units comprises: integrating the metadata binary value and character binary value into a combined binary value by padding zero or more bits between the metadata binary value and the character binary value and determining the unique set of code units that comprise the combined binary value in accordance with the formatting scheme.

Clause 7. The method of clause 6, wherein the padding is performed such that the combined binary value has a number of bits higher than a maximum number of bits that represents the character set.

Clause 8. The method of any of the preceding clauses 1 to 7, further comprising: parsing an electronic document for identifying sensitive tokens in the electronic document and repeating the method for each sensitive token of the sensitive tokens as the specific token, wherein the sensitive tokens are identified based on a security access criterion, wherein the storage of each sensitive token comprises replacing existing one or more code units of the sensitive token in the electronic document by the one or more sets of code units of the sensitive token. For example, the method of clause 8 may involve scanning an electronic document to identify sensitive tokens according to the security access criterion. For each sensitive token detected, the method of clause 1 is applied to that sensitive token, where the term “specific token” in clause 1 is to be understood as referring to the “sensitive token”.

Clause 9. The method of any of the preceding clauses 1 to 7, the specific token being a database attribute value that is stored in a database.

Clause 10. The method of any of the preceding clauses 1 to 9, wherein the character set comprises any one of UNICODE, ASCII or ISO-8859-1.

Clause 11. The method of any of the preceding clauses 1 to 10, wherein the formatting scheme is a formatting scheme of any one of: UTF encoding scheme or ASCII encoding scheme.

Clause 12. The method of any of the preceding clauses 1 to 11, wherein the formatting scheme is a formatting scheme of UTF-8 encoding scheme, wherein the set of code units is higher than four code units.

Clause 13. The method of clause 12, wherein the set of code units is five or six code units.

Clause 14. The method of any of the preceding clauses 1 to 13, the code units being bytes respectively.

Clause 15. The method of any of the preceding clauses 1 to 14, further comprising before the representation of the characters of the specific token, encrypting the specific token, wherein the characters of the specific token are encrypted characters of the encrypted specific token. For example, the method of clause 15 may specify that the specific token encoded in clause 1 is an encrypted version of an original token. Physically, the encrypted token and the original token may be similar in format or structure; however, they differ semantically because the encrypted token may obscure the original token's meaning, making it unreadable without decryption.

Computing environment 800 contains an example of an environment for the execution of at least some of the computer code involved in performing the inventive methods, such as code 900 for encoding data using an encoding scheme. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 5. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature whichh is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

CLOUD COMPUTING SERVICES AND/OR MICROSERVICES (not separately shown in FIG. 5): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. “A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

1. A method for encoding character data using an encoding scheme, the encoding scheme being configured to represent, in accordance with a formatting scheme, an original binary value of each character of a predefined character set into a unique set of one or more code units of the formatting scheme, the original binary value being obtained by a binary encoding technique, the method comprising for a specific token:
representing metadata descriptive of the specific token with a binary value, referred to as metadata binary value;
for each character in the specific token:
representing the character with a binary value, referred to as character binary value;
creating, in accordance with the formatting scheme, from at least part of the metadata binary value and the character binary value a unique set of code units including the at least part of the metadata binary value and the character binary value; and
storing the specific token by storing resulting one or more sets of code units.

2. The method of claim 1, wherein the at least part of the metadata binary value being a distinct part of the metadata binary value that is associated with the character.

3. The method of claim 1, wherein the at least part of the metadata binary value being the metadata binary value.

4. The method of claim 1, wherein the encoding scheme is a predefined multi-byte encoding scheme, wherein the representations is performed such that a concatenation of the at least part of the metadata binary value and the character binary value represents, in accordance with the binary encoding technique, an existing character of a multi-byte range of the character set, thereby replacing the existing character by the character and the associated at least part of the metadata.

5. The method of claim 1, wherein the encoding scheme is a predefined multi-byte encoding scheme, wherein the representation is performed such that a concatenation of the at least part of the metadata binary value and the character binary value represents, in accordance with the binary encoding technique, an unused character that is outside multi-byte ranges of the character set.

6. The method of claim 1, wherein creating the set of code units comprises: integrating the metadata binary value and character binary value into a combined binary value by padding zero or more bits between the metadata binary value and the character binary value and determining the unique set of code units that comprise the combined binary value in accordance with the formatting scheme.

7. The method of claim 6, wherein the padding is performed such that the combined binary value has a number of bits higher than a maximum number of bits that represents the character set.

8. The method of claim 1, further comprising: parsing an electronic document for identifying sensitive tokens in the electronic document and repeating the method for each sensitive token of the sensitive tokens as the specific token, wherein the sensitive tokens are identified based on a security access criterion, wherein the storage of each sensitive token comprises replacing existing one or more code units of the sensitive token in the electronic document by the one or more sets of code units of the sensitive token.

9. The method of claim 1, wherein the character set comprises any one of UNICODE™, ASCII or ISO-8859-1.

10. The method of claim 1, wherein the formatting scheme is a formatting scheme of any one of: UTF encoding scheme or ASCII encoding scheme.

11. The method of claim 1, wherein the formatting scheme is a formatting scheme of UTF-8 encoding scheme, wherein the set of code units is higher than four code units.

12. The method of claim 11, wherein the set of code units is five or six code units.

13. The method of claim 1, wherein the code units being bytes respectively.

14. The method of claim 1, further comprising: before the representation of the characters of the specific token, encrypting the specific token, wherein the characters of the specific token are encrypted characters of the encrypted specific token.

15. The method of claim 1, wherein the specific token being a database attribute value that is stored in a database.

16. A computer program product for encoding character data using an encoding scheme, the encoding scheme being configured to represent, in accordance with a formatting scheme, an original binary value of each character of a predefined character set into a unique set of one or more code units of the formatting scheme, the original binary value being obtained by a binary encoding technique, the computer program product being configured for a specific token, and comprising:
a computer-readable storage medium having computer-readable program code embodied therewith, the computer-readable program code configured to perform operations, comprising:
representing metadata descriptive of the specific token with a binary value, referred to as metadata binary value;
for each character in the specific token:
representing the character with a binary value, referred to as character binary value;
creating, in accordance with the formatting scheme, from at least part of the metadata binary value and the character binary value a unique set of code units including the at least part of the metadata binary value and the character binary value; and
storing the specific token by storing resulting one or more sets of code units.

17. A computer system for encoding character data using an encoding scheme, the encoding scheme being configured to represent, in accordance with a formatting scheme, an original binary value of each character of a predefined character set into a unique set of one or more code units of the formatting scheme, the original binary value being obtained by a binary encoding technique, the computer system being configured for a specific token, and the computer system comprising:
a processor set;
one or more computer-readable storage media; and
program instructions stored on the one or more computer-readable storage media to cause the processor set to perform operations comprising:
representing metadata descriptive of the specific token with a binary value, referred to as metadata binary value;
for each character in the specific token:
representing the character with a binary value, referred to as character binary value;
creating, in accordance with the formatting scheme, from at least part of the metadata binary value and the character binary value, a unique set of code units including at least part of the metadata binary value and the character binary value; and
storing the specific token by storing resulting one or more sets of code units.

18. The computer system of claim 17, wherein the at least part of the metadata binary value being a distinct part of the metadata binary value that is associated with the character.

19. The computer system of claim 17, wherein the at least part of the metadata binary value being the metadata binary value.

20. The computer system of claim 17, wherein the encoding scheme is a predefined multi-byte encoding scheme, wherein the representation is performed such that a concatenation of the at least part of the metadata binary value and the character binary value represents, in accordance with the binary encoding technique, an existing character of a multi-byte range of the character set, thereby replacing the existing character by the character and the associated at least part of the metadata.
